(19) United States
(12) Patent Application Publication
(10) Pub. No.: US 2007/0253279 A1
(43) Pub. Date: Nov. 1, 2007

(54) Homogenisation of Nanoscale Powders

(75) Inventors: Kai Schumacher, Hofheim (DE); Dieter Kerner, Hanau (DE); Ronald Ihmig, Neuberg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/544,485

(22) PCT Filed: Feb. 17, 2004
(86) PCT No.: PCT/EP04/01468

§ 371 Date: Aug. 4, 2005

(30) Foreign Application Priority Data
Feb. 28, 2003 (DE) 103 08 722.2

(51) Int. Cl. B01F 13/02

(52) U.S. Cl. 366/101

(57) ABSTRACT

Method for the homogenisation of nanoscale powders, in which mixtures of nanoscale powders having the same or different chemical composition and/or structure and in solid form are introduced in the presence of a regulable gas stream into a vessel, the gas stream being adjusted so that the nanoscale powders remain in suspension and are thoroughly mixed.

The present invention relates to a method and a device for homogenizing nanoscale powders.

In chemical processes relatively small variations in the reaction parameters often cannot be wholly avoided. For example the starting materials may vary as regards their composition, reaction flows or reaction temperatures, which can lead to changes in the product depending on the time in the production cycle. This in turn can mean that different batches of a product are not uniform. For most applications these changes, which as a rule are only very small, do not play a rôle. If desired a uniform product can be obtained by an homogenisation of different batches.

In applications in which nanoscale powders are used, for example the chemical-mechanical polishing of semiconductor substrates, even very small changes in the product quality of the nanoscale powders lead to significant differences in the polishing results. In contrast to coarser powders, the homogenisation of nanoscale powders is problematic since these can undergo structural changes during the homogenisation procedure. Thus, their aggregate structure or agglomerate structure may alter.

It is not possible to homogenise nanoscale powders with known homogenisation devices so that their structure and properties remain unchanged. DE-A-19832304 specifically claims a method by means of which nanoscale solids can be mixed. In the method described there grinding devices are used for the mixing, which may lead to structural changes in the mix. A further disadvantage is that an additive is necessary in the mixing procedure, which has to be removed again in a subsequent step. This method is uneconomical for homogenising relatively large amounts of nanoscale powders.

The object of the invention is to provide a method and a device by means of which it is possible to homogenise nanoscale powders so that their structure is not altered.

This object is achieved by a method for the homogenisation of nanoscale powders, which is characterised in that mixtures of nanoscale powders having the same or different chemical composition and/or structure are introduced in solid form in the presence of a regulable gas stream into a vessel, the gas stream being adjusted so that the nanoscale powders remain in suspension and are thoroughly mixed.

Homogenisation within the context of the invention is understood to mean the mixing of nanoscale powders of the same chemical composition, for example silicon dioxide, but of different structure and/or properties. The structure of the individual powders and the degree of aggregation or agglomeration is not changed by the homogenisation. This means that the values of properties conferred by the structure, such as for example the degree of compaction and incorporability in liquid media, are averaged without the structure of the individual types of powders being changed by the method.

Homogenisation is also understood to mean the intimate mixing of nanoscale powders of different chemical composition, for example silicon dioxide and aluminium oxide. In this method physical mixed oxides are formed in which the individual types of powders are separately present and in which no structural changes occur in the individual types of powders.

Nanoscale powders within the context of the invention are understood to denote those having primary particle sizes of 1 to 100 nm and that are present as such or in the form of aggregates or agglomerates.

The nature of the gas stream in the method according to the invention is not restricted, as long as no reaction takes place with the powders to be homogenised. Air or nitrogen may preferably be used. The amount of the gas stream may be adjusted by a suitable device so that the powders to be homogenised are maintained in suspension. In this way it is ensured that the powders do not settle and cannot compact for example. This in turn means that the properties of the powders remain unaffected.

Nanoscale powders in the form of metal oxide and/or metalloid oxide powders of pyrogenic origin are preferably used within the context of the invention. In this connection pyrogenic is understood to mean that the powders have been produced by flame oxidation or flame hydrolysis. Particularly suitable powders may be silicon dioxide, aluminium oxide, titanium dioxide, cerium oxide, zinc oxide, mixed oxides of the aforementioned compounds in the form of physical mixtures or chemical mixtures (co-fumed oxides) or doped metal oxides or metalloid oxides according to DE-A-19650500.

The nanoscale powders may be introduced continuously or batchwise into and/or removed from the vessel. Within the context of the invention it is preferred to introduce the powders continuously into the vessel until a powder density dependent on the chemical composition and structure of the powder is reached, and then fill suitable containers with the powders.

The method according to the invention for the homogenisation of pyrogenically produced metal oxides or metalloid oxides may particularly preferably be carried out during the production process and following the deacidification stage. A simplified flow diagram of the method for the production of a pyrogenic metal oxide or metalloid oxide is described in Ullmann's Encyclopedia of Industrial Chemistry, Vol. A 23, page 636, 5^{th} Edition.

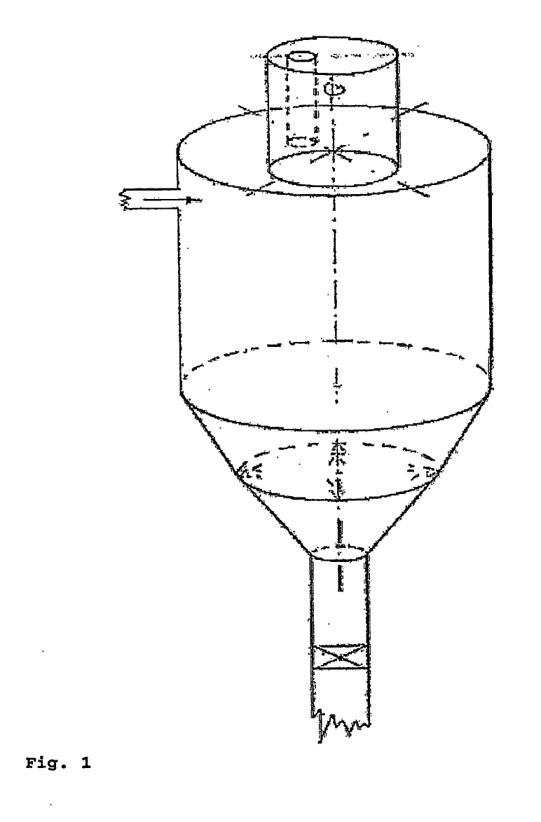

A suitable device for carrying out the method according to the invention is shown in FIG. 1, in which 1=outlet opening, 2=regulating device, 3=fluidisation ring (introduction of air or nitrogen at several points in the vessel), 4=inlet opening, 5=waste air opening with filter.

### EXAMPLES

### Example 1

A silo according to FIG. 1, equipped with fluidisation nozzles and having a total holding capacity of 4 m³, is filled with a total amount of 30 kg of pyrogenically produced silicon dioxide from three batches each of 10 kg with BET surfaces of 145, 155 and 158 m²/g and corresponding pH values of 3.8, 4.1 and 4.2. At the same time air (20 Nm³/hour) is fed in through nozzles and the powder is then packed in 10 kg bags. The analytical values of the first bag after 2 treatment with air, of the second bag after 4 hours' treatment and of the third bag after 6 hours' treatment are given in Table 1.

TABLE 1
BET surface and pH value before/after homogenisation

| Before Homogenisation | | | After Homogenisation | | |
|---|---|---|---|---|---|
| | BET* [m²/g] | pH | | BET* [m²/g] | pH |
| Batch 1 | 145 | 3.8 | Bag 1 | 148 | 4.0 |
| Batch 2 | 155 | 4.1 | Bag 2 | 152 | 3.9 |
| Batch 3 | 158 | 4.2 | Bag 3 | 151 | 4.0 |

*Accuracy ±2 m²/g

The desired homogenisation of the batches can be recognised. An approximately mean specific surface with values ranging from 148 to 152 m²/g is obtained. Additional TEM images that were obtained do not show any structural alterations after the homogenisation.

### Example 2

A silo according to FIG. 1, equipped with fluidisation nozzles and having a total holding capacity of 6 m³, is filled continuously with 60 kg/hour of pyrogenic silicon dioxide obtained from the process for the production of pyrogenic silicon dioxide, and having a BET surface of ca. 200 m²/g (determined on the basis of samples upstream of the silo; Table 2). 25 Nm³/hour of air are simultaneously fed in through the nozzles and the powder is homogenised. At the same time powder is continuously removed. The mean residence time in the silo is between 5 and 15 minutes. The filling height of the silo is constant. The analytical values of the first bag (start of the test), eighth bag (middle of the test) and last bag (end of the test) are shown in Table 2.

TABLE 2
BET surface and pH value before/after homogenisation
under continuous operation

| | |
|---|---|
| Before Silo | After Silo |

| Time | BET* [m²/g] | pH | BET* [m²/g] | pH |
|---|---|---|---|---|
| Start | 195 | 3.7 | 201 | 4.2 |
| Middle | 210 | 4.3 | 205 | 4.1 |
| End | 211 | 4.2 | 203 | 4.2 |

*Accuracy ±2 m²/g

1. A method for the homogenisation of nanoscale powders, wherein mixtures of nanoscale powders of identical or different chemical composition and/or structure and in solid form are introduced in the presence of a regulable gas stream into a vessel, the gas stream being adjusted so that the nanoscale powders remain in suspension and are thoroughly mixed and are then removed from the vessel.

2. The method according to claim 1, wherein the nanoscale powders are metal oxide powders and/or metalloid oxide powders of pyrogenic origin.

3. The method according to claim 1, wherein the nanoscale powders are continuously or discontinuously introduced into and/or removed from the vessel.

4. The method according to claim 1, wherein the homogenisation of the metal oxide powders and/or metalloid oxide powders of pyrogenic origin is incorporated in the process for the production of pyrogenic oxides, during the production process of these oxide powders and following a deacidification stage.
